(19) United States
(12) Patent Application Publication
(10) Pub. No.: US 2018/0037748 A1
(43) Pub. Date: Feb. 8, 2018

(54) METHOD FOR SEALING OXIDE PROTECTIVE LAYERS ON METAL SUBSTRATES

(71) Applicant: Henkel AG & Co. KGaA, Duesseldorf (DE)

(72) Inventors: Nicole Auweiler, Dormagen (DE); Ulrich Dawidowski, Wildberg (DE)

(21) Appl. No.: 15/789,186

(22) Filed: Oct. 20, 2017

Related U.S. Application Data
(63) Continuation of application No. PCT/EP2016/059465, filed on Apr. 28, 2016.

(30) Foreign Application Priority Data
Apr. 30, 2015 (DE) 102015208076.5

(51) Int. Cl. C09D 5/08; B05D 3/00; B05D 1/02; B05D 1/18; C09D 123/08; C25D 9/04

(52) U.S. Cl. CPC C09D 5/08; C09D 123/0876; C25D 9/04; B05D 1/02; B05D 1/18; B05D 3/007

(57) ABSTRACT

A method for sealing oxide protective layers on metal substrates using aqueous compositions containing a copolymer or a copolymer mixture of at least one aliphatic and acyclic alkene with at least one α,β-unsaturated carboxylic acid in a water-dispersed and/or water-dissolved form with a copolymer or copolymer mixture acid number of at least 20 mg KOH/g, but not more than 200 mg KOH/g, the invention also relates to the use of such copolymers or such a copolymer mixture for sealing protective layers based on oxides and/or hydroxides of the elements Si, Ti and/or Zr on an aluminum substrate where the protective layer has a thickness of at least 2 microns.

The present invention relates to a method for sealing oxide protective layers on metal substrates, using aqueous compositions comprising a copolymer or a copolymer mixture of at least one aliphatic and acyclic alkene with at least one α,β-unsaturated carboxylic acid in water-dispersed and/or water-dissolved form, having an acid number of the copolymer or of the copolymer mixture of at least 20 mg KOH/g, but no more than 200 mg KOH/g. In particular, the invention also relates to the use of such copolymers, or of such a copolymer mixture, for sealing protective layers based on oxides and/or hydroxides of the elements Si, Ti and/or Zr on an aluminum substrate, wherein the protective layer has a thickness of at least 2 μm.

The electrolytic generation of oxide layers on metal substrates, and in particular on aluminum, is a widely common method in the prior art for producing anti-corrosive and/or decorative coatings, for example using anodization or plasma electrolytic deposition processes. Electrolytically produced oxide protective layers protect the metallic material against corrosion and weathering, and in general additionally increase the surface hardness and abrasion resistance of components made of these materials.

While in the case of the anodization method an electrolytic oxide layer on aluminum substrates is accessible by applying an anodic potential, which is then made substantially of oxides and hydroxides of aluminum, the plasma electrolytic method also yields oxide layers that are substantially composed of oxides and hydroxides of metal elements present in the electrolyte due to the decomposition of the electrolyte in the plasma. Furthermore, in addition to aluminum or materials provided with an aluminum layer, it is also possible to apply an oxide protective layer to other materials such as magnesium, titanium and zinc when using the plasma electrolytic method. A typical plasma electrolytic method for applying a protective layer based on titanium oxide is described in WO 2003/029529 for the materials magnesium and aluminum.

The electrical general conditions of an anodization method usually deviate considerably from those of a plasma electrolytic method for generating oxide protective layers. While the anodization method is conducted, as a function of the electrolyte, at current densities in the range of 1 to 2 A/dm² and voltages of up to 25 V, protective layers produced plasma electrolytically are produced on aluminum in a similar layer thickness in a pulsed operation using peak voltages of up to 500 V, wherein average power densities are 5 to 10 A/dm². The thickness of the protective layers applied in electrolytic methods can be set substantially variably, however layer thicknesses of at least 2 μm are necessary for the property of the oxide protective layer to provide protection against corrosion during exposure to moisture or upon contact with liquids, wherein typical layer thicknesses that satisfy industrial requirements are in the range of 5 to 50 μm.

The methods for applying oxide protective layers outlined here have in common that, due to the nature of the deposition processes continued under electrolytic conditions, porous layers are formed, which are not able to offer lasting effective protection against highly corrosive media. Typically, the freshly produced oxide protective layers in the prior art are finished in different ways so as to seal the pores. These processes following the electrolytic process are referred to as bonding or sealing in technical jargon. In principle, any porous oxide protective layer can be sealed, regardless of the method in which it is provided. However, specific finishing methods have become established for the common methods for forming oxide protective layers and the metal substrates usually coated in these methods. Established methods for sealing exist, in particular, for electrolytically applied oxide protective layers on aluminum substrates, such as cold sealing in the presence of metal catalysts or hot sealing using aqueous compositions.

Frequently, inorganic compounds are added to the sealing bath, which accelerate the hydrolysis of the porous aluminum oxide layer and cause an additional oxide layer structure or at least a surface modification of the oxide layer. Sealing baths in the prior art can contain water-soluble silicates so as to additionally increase the corrosion resistance of the oxide layer (U.S. Pat. No. 6,686,053; EP 1 873 278 A1) or hydrophilize the material surface when producing lithographic plates (U.S. Pat. No. 3,181,461, U.S. Pat. No. 2,714,066).

In some fields of application, sealing the porous oxide protective layers furthermore was to generate a suitable paint primer. Traditional sealing, which relies on a mechanism involving hydrolysis, swelling and subsequent bonding during drying, do not appear suitable for this purpose since the sealed surfaces usually have a lower roughness, and thus offer fewer anchoring points for an organic coating.

Sealing porous materials with the aid of crosslinking organic resins is known, in general, from vacuum impregnation; this method, however, has very complex process engineering. Moreover, it must be ensured that sealing takes place that is suitable on a multitude of oxide protective layers for suppressing the corrosion of the metal substrate. In general, neither the hot and cold sealing methods known from the prior art, which, for example, do not result in any subsequent bonding of titanium oxide-based protective layers, nor arbitrary organic resins crosslinked in the pores of the oxide protective layer are able to accomplish this.

WO 2012/174386 describes that plasma electrolytically deposited titanium oxide-based protective layers on aluminum are treated with an aqueous dispersion of a urethane resin for the purpose of sealing and imparting a low coefficient of friction. There, aluminum materials thus treated are proposed for cylinder liners in crankcases of internal combustion engines.

It was the object of the present invention to develop a method for sealing porous protective layers, which can be used to effectively protect a multitude of metal substrates against highly corrosive media. In particular, this was to be accomplished for aluminum substrates that are provided with a protective layer based on oxides and/or hydroxides of the elements Si, Ti and/or Zr. Furthermore, the method was to enable the application of the sealing medium by way of conventional application methods, such as spraying and dipping.

This object was now achieved by a method for sealing oxide protective layer on metal substrates, in which the metal substrate provided with the protective layer is brought in contact with
(i) an aqueous composition for sealing, comprising
   a) at least 1 wt. % of a copolymer or of a copolymer mixture of at least one aliphatic and acyclic alkene with at least one α,β-unsaturated carboxylic acid in water-dispersed and/or water-dissolved form, based on the aqueous composition, wherein the acid number of the copolymer or of the copolymer mixture is at least 20 mg KOH/g, but no more than 200 mg KOH/g; and
   b) a cross-linking agent,
and subsequently
(ii) drying and/or curing takes place while supplying thermal energy, wherein the aqueous composition for sealing in step (i) has a flow time of no more than 50 seconds, measured by way of a 4 mm DIN flow cup.

According to the invention, sealing refers to one or more treatment steps, comprising at least one wet-chemical treatment step, which are suitable for reducing the porosity of the protective layer and/or for reducing the free substrate surface. Such suitability exists whenever an amount of film-forming organic polymer is present in the wet-chemical treatment step.

According to the invention, a protective layer refers to those non-metallic coatings which are applied onto the metallic substrate in a layer thickness of greater than or equal to 2 μm, wherein the layer thickness can be determined by way of eddy current methods as an arithmetic mean across at least 5 measuring points per square decimeter, each having a contact surface of at least one square millimeter, but no more than one square centimeter.

According to the invention, a protective layer is oxide when the coating is substantially based on oxides and/or hydroxides, preferably based oxides and/or hydroxides of elements that are not main components of the metal substrate, and in particular based oxides and/or hydroxides of the elements Si, Ti, Zr, Nb, Ta and/or Sn, wherein the proportion of non-metals is preferably smaller than 10 at %.

For an amount of film-forming organic polymer sufficient for sealing, according to the invention methods are preferred in which the proportion of the copolymer or of the copolymer mixture, based on the aqueous composition, is at least 5 wt. %. For the advantageous application of the composition for sealing by way of dipping or spraying, however, it is preferred when the proportion of the copolymer or of the copolymer mixture is no more than 30 wt. %, and particularly preferably no more than 20 wt. %, in each case based on the composition for sealing.

In this connection, it must also be ensured that the viscosity of the composition for sealing does not exceed a value at which an application of the composition by way of dipping or spraying is only possible with complex process engineering measures, such as an increased application temperature or an increased spraying pressure. Accordingly, the composition for sealing shall be formulated in such a way that a flow time, measured by way of a 4 mm DIN flow cup, of no more than 50 seconds is present, and preferably the flow time is no more than 40 seconds. Conversely, however, it is preferred that the flow time, measured by way of a 4 mm DIN flow cup, is at least 20 seconds, so as to ensure that a sufficient amount of wet film remains on the surfaces and the edges of the component to be sealed. The flow time is to be determined at 20° C. in accordance with the standard DIN 53211. A person skilled in the art will essentially be familiar with methods for setting the viscosity by way of rheological additives.

According to the present invention, a polymer is dissolved in water or dispersed in water when it assumes an average particle diameter of less than 1 μm in the aqueous phase. The average particle diameter can be determined in accordance with ISO 13320:2009 by way of laser diffraction from cumulative particle size distributions in the form of what is known as the D50 value directly in the respective composition at 20° C.

According to the invention, a copolymer mixture encompasses mixtures of chemically and/or structurally different copolymers of at least one aliphatic and acyclic alkene with at least one α,β-unsaturated carboxylic acid. In a copolymer mixture of a paint formulation according to the invention, for example, copolymers that comprise different alkenes or different α,β-unsaturated carboxylic acids as comonomers, or that comprise a different number of otherwise identical comonomers in the copolymer, may be present simultaneously.

According to the invention, the acid number is a characteristic value to be determined by way of experimentation, which is a measure of the number of free acid groups in the copolymer or in the copolymer mixture. The acid number is determined by dissolving a weighed amount of the copolymer or copolymer mixture in a solvent mixture of methanol and distilled water at a volume ratio of 3:1, and subsequently potentiometrically titrating with 0.05 mol/L KOH in methanol. The potentiometric measurement is carried out by way of a combination electrode (LL-Solvotrode® from Metrohm; reference electrolyte: 0.4 mol/L tetraethylammonium bromide in ethylene glycol). The acid number corresponds to the added amount of KOH in milligram per gram of copolymer or copolymer mixture at the inflection point of the potentiometric titration curve.

If the acid number of the copolymers or of the copolymer mixture of alkenes and α,β-unsaturated carboxylic acids is below 20 mg KOH/g, a composition for sealing according to the present invention does not have sufficient wetting and adhesion after the same has cured on the oxide protective layers of the metal substrates, and is consequently also not suitable for sealing the pores of these protective layers. Conversely, an acid number of the copolymers or of the copolymer mixture of alkenes and α,β-unsaturated carboxylic acids above 200 mg KOH/g as a sealing component of the composition for sealing results in an insufficient barrier action after curing of the sealed components with respect to corrosively acting ions in anhydrous media, and the metal substrate per se is not sufficiently protected.

The weight proportion of the aliphatic and acyclic alkenes in the copolymer or in the copolymer mixture is preferably at least 40 wt. %, and particularly preferably at least 60 wt. %, but preferably no more than 95 wt. %. This ensures that the permeability of the composition, which has cured and/or dried on the oxide protective layer to be sealed and comprises the copolymer or the copolymer mixture, for ions upon contact with aqueous media is maximally reduced, while also offering sufficient adhesion to the metal substrate provided with the oxide protective layer.

Preferred aliphatic and acyclic alkenes of the copolymers or the copolymer mixture present according to the invention in the composition for sealing are selected from ethene, propene, 1-butene, 2-butene, isobutene, 1,3-butadiene and/or 2-methylbuta-1,3-diene, and particularly preferably ethene and/or propene.

Preferred α,β-unsaturated carboxylic acids of the copolymers or the copolymer mixture present according to the invention in the composition for sealing are selected from cinnamic acid, crotonic acid, fumaric acid, itaconic acid, maleic acid, acrylic acid and/or methacrylic acid, particularly preferably acrylic acid and/or methacrylic acid, and in particular acrylic acid.

Further comonomers that may be an additional component of the copolymers or copolymer mixture in an aqueous composition for sealing in the method according to the invention are selected from esters of α,β-unsaturated carboxylic acids, and preferably linear or branched alkyl esters of acrylic acid and/or methacrylic acid having no more than 12 carbon atoms in the aliphatic functional group. Such comonomers improve the adhesion of the cured and/or dried composition for sealing on the metal substrates provided with the oxide protective layer due to increased mobility of the polymer skeleton, which, in turn, facilitates the orientation of the surface affinity acid groups to oxide and metallic surfaces. This effect comes to bear in particular with low acid numbers of the copolymer below 100 mg KOH/g. In general, it has been shown that low acid numbers of the copolymers or the copolymer mixture improve the barrier properties of the cured and/or dried composition for sealing when exposed to aqueous media. Accordingly, copolymers or copolymer mixtures that additionally comprise the above-described comonomers and have acid numbers below 100 mg KOH/g., and in particular below 60 mg KOH/g, are preferred according to the invention.

To achieve good film forming during curing of the composition for sealing, it is necessary for the copolymer dissolved and/or dispersed in water, or the copolymer mixture dissolved and/or dispersed in water, to transition into the fused state after volatilization of the aqueous phase. To satisfy this requirement, copolymers or copolymer mixtures that, per se, have a glass transition temperature of no more than 80° C., and particularly preferably of no more than 60° C., are preferred. Copolymers or copolymer mixtures composed of alkenes and α,β-unsaturated carboxylic acids having a weight average molecular weight M_{w} of no more than 20,000 u usually have this property, so that copolymers or copolymer mixtures having a weight average molecular weight of no more than 20,000 u, and in particular of no more than 15,000 u, are preferred for the composition for sealing in methods according to the invention.

In a preferred method, the acid groups of the copolymer dissolved and/or dispersed in water, or of the copolymer mixture dissolved and/or dispersed in water, are present in the composition for sealing in at least partially neutralized form. This measure increases the ability of the copolymers to self-emulsify in the aqueous phase, which tends to result in smaller particle sizes of the film-forming organic components, which, in turn, bring about more effective sealing the pores of the protective layer. Accordingly, a neutralizing agent is preferably additionally present in the composition for sealing.

Preferably, ammonia, amines, metallic aluminum and/or zinc, preferably in powder form, and water-soluble oxides and hydroxides of the elements Li, Na, K, Mg, Ca, Fe(II) and Sn(II) are suitable neutralizing agents, which are additionally present in the composition for sealing in a preferred method. A person skilled in the art is aware at this point that the neutralizing agents undergo a neutralization reaction with the components of the composition for sealing in keeping the function of the neutralizing agents, and therefore may only be indirectly detectable in the form of the reaction products thereof. For example, metallic aluminum or zinc powder reacts in the aqueous phase to yield the corresponding hydroxides, developing hydrogen, and the hydroxides, in turn, cause the neutralization of acid groups of the copolymer or of the copolymer mixture, so that ultimately only the cations of the elements aluminum or zinc are detectable. The neutralizing agents shall therefore only be understood to act as a formulating auxiliary in the respective composition for sealing.

Ammonia and amines are particularly preferred neutralizing agents since these, during curing of the applied composition for sealing as a result of the supply of thermal energy, transition into the gas phase, and therefore do not remain in the cured seal. Preferred amines that can be used as neutralizing agents in aqueous compositions for sealing are morpholine, hydrazine, hydroxylamine, monoethanolamine, diethanolamine, triethanolamine, dimethylethanolamine and/or diethylethanolamine.

The neutralization of the acid groups of the copolymer or of the copolymer mixture preferably takes place to such a degree that at least 20%, and particularly preferably at least 30% of the acid groups is present in neutralized form. High degrees of neutralization of the acid groups of the copolymer or of the copolymer mixture above 50% are to be avoided in a preferred embodiment of the method, since this causes a considerable proportion of the copolymer or of the copolymer mixture to be present dissolved in water and to contribute to very high viscosity, which can be disadvantageous for applying the composition for sealing.

In general, it is preferred for the preservation of optimal rheological properties of the compositions for sealing to add the neutralizing agent to the formulation in such an amount that, based on 1 g of the copolymer or of the copolymer mixture, at least 4/z μmol, and preferably at least 6/z μmol, each multiplied by the acid number of the copolymer or of the copolymer mixture, of neutralizing agent is present, preferably however no more than 10/z μmol, and particularly preferably no more than 8/z μmol, multiplied by the acid number of the copolymer or of the copolymer mixture. The divisor z is a natural number and corresponds to the equivalent number of the neutralization reaction. The equivalent number indicates the number of moles of acid groups of the copolymer or of the copolymer mixture that one mole of the neutralizing agent is able to neutralize.

The aqueous composition for sealing necessarily comprises a cross-linking agent, which according to the invention must be suitable for cross-linking the copolymer or the copolymer mixture, which is to say form a network having a higher molecular weight compared to the copolymers or the copolymer mixture. The cross-linking agent itself may form cross-linking sites via covalent or coordinate bonds with the neutralized or free acid groups of the copolymer or of the copolymer mixture, it may be joined via the copolymers or different copolymers of the copolymer mixture, or it may only catalyze intramolecular cross-linking, for example the intramolecular formation of anhydride by cleaving water molecules.

It has been found the formation of networks having a higher molecular weight by way of cross-linking agents, which are incorporated into the polymeric skeleton either in in a covalent or coordinate manner, is advantageous for efficiently sealing the oxide protective layers against corrosive media. Accordingly, preferred cross-linking agents according to the invention are those that are selected from water-soluble inorganic compounds of the elements Zr and/or Ti and/or from water-soluble and/or water-dispersible aminoplasts and/or carboimides. Organic compound-based cross-linking agents are water-soluble and/or water-dispersible if they assume an average particle diameter of less than 1 μm immediately after the application of a one-minute shearing force having an energy input of 10³ joule per second per liter at 20° C. in deionized water (κ<1 ρScm⁻¹). The average particle diameter can be determined in accordance with ISO 13320:2009 by way of laser diffraction from cumulative particle size distributions as what is known as the D50 value.

Suitable cross-linking agents based on water-soluble inorganic compounds of the elements Zr and/or Ti are selected from alkoxides and/or carbonates, particularly preferably from tetrabutoxyzirconate, tetrapropoxyzirconate, tetrabutoxytitanate, tetrapropoxytitanate, ammonium zirconium carbonate and/or ammonium titanium carbonate, in particular preferred ammonium zirconium carbonate. Such compounds are considered to be water-soluble if the solubility thereof in deionized water (κ<1 ρScm⁻¹) at 20° C. is at least 1 g/L, based on the respective element Zr and/or Ti.

To achieve sufficient cross-linking of the copolymer or of the copolymer mixture in method step ii) based on the water-soluble compounds of the elements Zr and/or Ti, it is preferred when the weight proportion of such a cross-linking agent is determined as the weight proportion of the elements Zr and/or Ti, based on the solids content of the copolymer or of the copolymer mixture, divided by the dimensionless acid number of the copolymer or of the copolymer mixture in grams KOH/g greater than 0.04.X_{zr}+0.02.X_{Ti}. Conversely, it is preferred that this very weight ratio divided by the dimensionless acid number of the copolymer or of the copolymer mixture in grams KOH/g is preferably smaller than 0.12.X_{Zr}+0.06.X_{Ti} to as to yield stable compositions for sealing. X_{Zr} and X_{Ti} are the respective mass fractions of the elements Zr or Ti, based on the total proportion of the elements Zr and Ti of the cross-linking agent.

In a preferred embodiment of the method, the cross-linking agent is based on organic compounds that bring about covalent cross-linking of the copolymers or of the copolymer mixture in method step ii), and thus in particular those selected from water-soluble and/or water-dispersible aminoplasts and/or carboimides.

Particularly suitable aminoplast cross-linking agents are based on melamine, urea, dicyandiamide, guanamine and/or guanidine. In particular, melamine formaldehyde resins are preferred aminoplast cross-linking agents, having a molar ratio of formaldehyde:melamine of preferably greater than 1.5.

As an alternative or in addition, the cross-linking agent in the composition for sealing is a carbodiimide. Carbodiimides comprise at least one diimide structural unit of the type —C═N═C—. However, preferably they are polyfunctional having a diimide equivalent weight in the range of 300 to 500 grams of the polyfunctional compound per molecule of diimide groups. In particular, preferred carbodiimides are those derived from isocyanates comprising at least two isocyanate groups by way of decarboxylation, and in particular those of the general chemical formula (I):

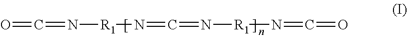

where n: natural integer in the range from 1 to 20;
R₁: aromatic, aliphatic or alicyclic functional group comprising no more than 16 carbon atoms.

The isocyanate groups, in turn, are preferably blocked with hydrophilic protecting groups, which, per se, impart improved water dispersibility or water solubility to the carbodiimide. Suitable protecting groups of a hydrophilic nature are, for example, hydroxyalkylsulfonic acids, hydroxyalkylphosphonic acids, hydroxyalkylphosphoric acids, polyethylene glycols, as well as tertiary or quatemary aminoalkyl alcohols and aminoalkyl amines.

In a particularly preferred embodiment, the cross-linking agent of the composition for sealing is thus selected from carbodiimides comprising blocked terminal isocyanate groups according to general chemical formula (II):

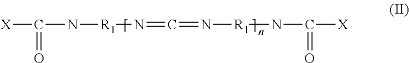

where n: natural integer in the range from 1 to 20;
R₁: aromatic, aliphatic or alicyclic functional group comprising no more than 16 carbon atoms.
X: —NH—R₁—N(R₁)₂, —O—R₁—N(R₁)₂, —NH—R₁—N(R₁)₃Y, —O—R₁—N(R₁)₃Y, —O—R₁—SO₃Z, —O—R₁—O—PO₃Z, —O—R₁—PO₃Z, —O—(C₂H₄)ₚ—OH, —O—(C₃H₆)ₚ—OH
where Y: hydroxide, chloride, nitrate, sulfate;
where Z: hydrogen, ammonium, alkali metal or alkaline earth metal;
where p: natural integer in the range from 1 to 6.

Preferred diisocyanates that result in the corresponding carbodiimides by way of decarboxylation are, for example, hexamethylene diisocyanate, cyclohexane-1,4-diisocyanate, xylylene diisocyanate, isophorone diisocyanate, dicyclohexylmethane-4,4-diisocyanate, methylcyclohexane diisocyanate and tetramethylxylylene diisocyanate, 1,5-naphthylene diisocyanate, 4,4-diphenylmethane diisocyanate, 4,4-diphenyldimethylmethane diisocyanate, 1,3-phenylene diisocyanate, 1,4-phenylene diisocyanate, 2,4-toluenylene diisocyanate, 2,6-toluenylene diisocyanate.

In principle, it is preferred that the organic cross-linking agent, and in particular the aminoplast and/or the carboimide, has a weight average molecular weight M_{w} of no more than 2,500 u, and particularly preferably of no more than 1,500 u, so as to ensure sufficient cross-linking with the copolymer or the copolymer mixture.

In a particularly preferred embodiment of the method according to the invention for sealing, the aqueous composition for sealing in step (i) comprises:
a) 0.5 to 15 wt. %, and preferably 2 to 10 wt. % of the above-described copolymer or of the copolymer mixture;
b) 0.5 to 10% by weight, and preferably 1 to 6 wt. % of a cross-linking agent based on water-soluble and/or water-dispersible aminoplasts and/or carboimides;
c) up to 6 wt. % of a neutralizing agent, selected from ammonia and/or amines, preferably alkanolamines;
d) up to 6 wt. %, but preferably at least 0.1 wt. % of a thickener, selected from polymeric organic compounds that do not represent compounds a), preferably from polyacrylates, which in the form of the free acid thereof have an acid number of more than 200 mg/g KOH;
e) up to 5 wt. % of further auxiliary agents, preferably selected from corrosion inhibitors, leveling agents, stabilizers, surfactants, and pigments, which are generally known to a person skilled in the art from the field of paint formulation; and
f) less than 5 wt. % organic solvents.

In a preferred method according to the invention, the bringing into contact in step (i) takes place by applying a wet film of the aqueous composition for sealing by way of spraying or by way of a dipping process, preferably by way of a dipping process, wherein, after termination, preferably directly thereafter excess wet film is removed before step (ii) is carried out so as to form a wet film adhering in a homogeneous film thickness.

The termination of the bringing into contact by way of dipping takes place, for example by removing the metal substrate or lowering the liquid level, for example. Excess wet film can be removed by allowing it to drip off, or by blowing it off, or by squeezing it off the metal substrate. The composition for sealing is formulated in such a way that the oxide protective layer experiences optimal wetting and thus the aforementioned conventional application methods can be carried out without difficulty, and no special technical measures are required. While bringing into contact by way of vacuum impregnation, for example, is possible, this is not necessary to achieve satisfactory sealing.

During method step i), a contact time of the composition for sealing with the metal substrate provided with the oxide protective layer of at least 1 second, and preferably of at least 10 seconds, is preferred. For reasons of procedural economy, however, the contact time is preferably no more than 120 seconds, and particularly preferably no more than 60 seconds.

In the method according to the invention for sealing, the bringing into contact of the metal substrate bearing the oxide protective layer with the aqueous composition comprising the film-forming polymer is followed by a method step for curing. In a preferred procedure, thermal energy is supplied in such a way that a peak temperature of the substrate of at least 120° C., and particularly preferably of at least 160° C., but preferably of less than 200° C. is measured (so-called peak metal temperature).

Furthermore, it is preferred that, after step ii), an amount of organic components of the aqueous composition for sealing remains on the oxide protective layer which is such that, with complete pyrolysis, it releases an amount of at least 1 g CO₂, and preferably at least 4 g CO₂, but no more than 20 g CO₂, each per square meter. Complete pyrolysis can be achieved at 500° C., supplying air (so-called “gasification”) when the pyrolysis temperature is maintained for a sufficiently long time.

In a preferred method, the metal substrate provided with the oxide protective layer is selected from aluminum, magnesium and/or titanium, preferably from aluminum and/or magnesium, and particularly preferably from aluminum, and the alloys thereof, wherein the element of the particular substrate accounts for at least 50 at % of alloys of these substrates. The reason that these substrates are preferred is the special affinity of these substrates for the film-forming organic polymer present in the composition for sealing, and additionally the property thereof in conventional technical methods for anti-corrosive initial treatment to form oxide protective layers having high porosity, so that sealing for these substrates immediately subsequent to such an anti-corrosive initial treatment is particularly important.

In a preferred variant of the method according to the invention, in which the metal substrate is selected from aluminum and/or magnesium, the oxide protective layer is substantially made of oxides and/or hydroxides of the elements Si, Ti and/or Zr. In any case, a protective layer will be substantially made of oxides and/or hydroxides of these elements when the proportion of non-metals in the protective layer is smaller than 10 at %, and the proportion of the elements Si, Ti and Zr in the protective layer, based on the total proportion of all metals, is at least 30 at %, and preferably at least 50 at %.

Such oxide protective layers on the substrates aluminum and magnesium are accessible by way of electrolytic methods. In particular, electrolytic methods in which the substrates are at least partially connected as the anode, and the electrolyte comprises water-soluble compounds of the elements Si, Ti and/or Zr, are suitable for providing oxide protective layers that are substantially made of oxides and/or hydroxides of the elements Si, Ti and/or Zr. Compounds as components in electrolytes for the deposition of oxide protective layers are considered to be water-soluble if the solubility thereof in deionized water (κ<1 ρScm⁻¹) at 20° C. is at least 1 g/L, based on the respective element Si, Ti and/or Zr.

In particular, electrolytic methods in which at least partially an electrical voltage for the deposition of a protective layer is applied to the substrate which is above the decomposition voltage of the aqueous electrolyte are suitable, wherein the substrate is connected as the anode, and preferably an average voltage of at least 50 V, and particularly preferably of at least 200 V, is impressed when the voltage is applied for the deposition of a protective layer. Such methods are known to a person skilled in the art as plasma electrolytic methods from the prior art (WO 2003/029529 A1, WO 2006/047501).

In a further aspect, the present invention consequently comprises a method for the anti-corrosive treatment of a metal substrate selected from aluminum and/or magnesium, in which:

(1) the metal substrate is brought in contact with an aqueous electrolyte comprising water-soluble compounds of the elements Si, Ti and/or Zr, and during the bringing into contact at least partially an electrical voltage for the deposition of a protective layer is applied to the substrate which is above the decomposition voltage of the aqueous electrolyte, wherein the substrate is connected as the anode, and preferably an average voltage of at least 50 V, and particularly preferably of at least 200 V, is impressed when the voltage is applied for the deposition of a protective layer;

(2) with or without an interposed rinsing and drying step, the metal substrate provided with the protective layer is brought in contact with an aqueous composition for sealing, which has a flow time of no more than 50 seconds, measured by way of a 4 mm DIN flow cup, comprising:
a) a copolymer or a copolymer mixture of at least one aliphatic and acyclic alkene with at least one α,β-unsaturated carboxylic acid in water-dispersed and/or water-dissolved form, wherein the acid number of the copolymer or of the copolymer mixture is at least 20 mg KOH/g, but no more than 200 mg KOH/g; and
b) a cross-linking agent;
and subsequently

(3) drying and/or curing of the wet film applied in step (2) takes place while supplying thermal energy.

The above-described preferred embodiments of the method according to the invention for sealing are likewise preferred embodiments of method steps (2) and (3) of the method according to the invention for the anti-corrosive treatment of a metal substrate.

The present invention furthermore comprises the use of an aqueous composition comprising a copolymer or a copolymer mixture of at least one aliphatic and acyclic alkene with at least one α,β-unsaturated carboxylic acid in water-dispersed and/or water-dissolved form, wherein the acid number of the copolymer or of the copolymer mixture is at least 20 mg KOH/g, but no more than 200 mg KOH/g, and at least 20%, but no more than 60% of the acid groups of the copolymer or of the copolymer mixture in water-dispersed form are present in a neutralized state, for sealing a protective layer based on oxides and/or hydroxides of the elements Si, Ti and/or Zr on an aluminum substrate, wherein the protective layer has a thickness of at least 2 μm. The protective layer is preferably based on oxides and/or hydroxides of the element Ti and has a density of less than 3.5 g/cm³.

In any case, the protective layer is based on oxides and/or hydroxides of the element Ti when the proportion of non-metals in the protective layer is smaller than 10 at %, and the proportion of the element Ti in the protective layer, based on the total proportion of all metals, is at least 30 at %, and preferably at least 50 at %.

The density of the protective layer is defined by the layer structure in g/cm² divided by the layer thickness in cm, wherein the layer structure is determined by way of experimentation from the difference in weight, per unit area, of an aluminum sheet prior to and after the application of the protective layer in g/cm², reduced by the proportion, per unit area, of the difference in weight in cm² caused by the dissolution of the aluminum substrate, again determined from the difference of the proportion of dissolved aluminum in the liquid medium of the wet-chemical process prior to and after the application of the protective layer. The most common wet-chemical method for applying this special protective layer onto aluminum is an electrolytic, and preferably a plasma electrolytic, method.

### EXEMPLARY EMBODIMENTS

The formulations in Table I were used to seal aluminum sheets (AA6014; test sheets from Chemetall) coated by way of plasma electrolysis.

For this purpose, initially cleaned and degreased aluminum sheets were potentiostatically coated for 3 minutes in an electrolyte (pH value 2.5) comprising 4.5 g/L phosphoric acid and 12 g/L hexafluorotitanic acid at a voltage of 435 V. The resulting titanium oxide- and titanium hydroxide-based protective layer had a layer thickness of 10 to 12 μm, measured by way of an eddy current probe in accordance with DIN-ISO 2360 (DUALSCOPE@ MP40E-S with measuring probe ED10; Fischer).

The sheets thus coated were then dipped for 30, 60 or 120 seconds into formulations A to C and subsequently hung for one minute for dripping. The wet film remaining on the metal sheets after dripping was then cured in the furnace at 230° C. for 2 minutes. The layer thickness of the cured seal was approximately 8 μm after measurement according to the aforementioned eddy current method.

TABLE 1
Aqueous formulations A to C for sealing, comprising
an ethylene-acrylic acid copolymer

| | A | B | C |
|---|---|---|---|
| Ethylene acrylic acid copolymer | 5.8 | 5.8 | 5.6 |
| (18 to 20 wt. % acrylic acid) | | | |
| Dimethylethanolamine | 1.4 | 1.4 | — |
| Ammonia (15 wt. %) | — | — | 0.7 |
| Bacote ® 20 ¹ (Mel | 2.0 | — | — |
| Chemicals) | | | |
| Cymel ® 327 ² (Allnex) | — | 4.0 | 4.0 |
| Polyacrylate ³ | 0.5 | 0.5 | 0.5 |
| 4 mm DIN flow time in seconds | 22 | 22 | 22 |

¹ Basic ammonium zirconium carbonate solution (20 wt. % Zr)
² Melamine resin (drying over 20 minutes at 230° C.)
³ Thickener having a pH value of 2.5; 30 to 70 mPas according to ISO 2555

The sealed plasma electrolytically coated aluminum sheets were subjected to a CASS test (240 hours) in accordance with DIN EN ISO 9227. After the loading time, all sealed metal sheets had a degree of blistering (0 (S0) to 5 (S5)) in accordance with DIN EN ISO 4628-1 of 0 (S0), and a degree of rusting (0 to 5) in accordance with DIN EN ISO 4628-3 of maximally 1. The unsealed plasma electrolytically coated aluminum sheet exhibited a degree of rusting of 5.

1. A method for sealing oxide protective layers on metal substrates, wherein the metal substrate provided with the oxide protective layer is subjected to the following steps:
(i) contacting with an aqueous composition for sealing, comprising:
a) at least 1 wt. % of a copolymer or of a copolymer mixture of at least one aliphatic and acyclic alkene with at least one α,β-unsaturated carboxylic acid in water-dispersed and/or water-dissolved form, based on the aqueous composition, wherein of the copolymer or the copolymer mixture has an acid number that is at least 20 mg KOH/g, but no more than 200 mg KOH/g; and
b) a cross-linking agent;
and subsequently
(ii) drying and/or curing takes place while supplying thermal energy to thereby form a cured seal;
wherein the aqueous composition for sealing in step (i) has a flow time of no more than 50 seconds, measured by way of a 4 mm DIN flow cup.

2. The method according to claim 1, wherein the copolymer or the copolymer mixture is present in an amount of at least 5 wt. %, but no more than 30 wt. %, based on the aqueous composition.

3. The method according to claim 1, wherein the cross-linking agent b) is selected from water-soluble inorganic compounds of the elements Zr and/or Ti, from water-soluble and/or water-dispersible aminoplasts and/or carboimides.

4. The method according to claim 1, wherein the at least one aliphatic and acyclic alkene of the copolymer or the copolymer mixture of the aqueous composition for sealing in step (i) is selected from ethene, propene, 1-butene, 2-butene, isobutene, 1,3-butadiene and/or 2-methylbuta-1,3-diene.

5. The method according to claim 1, wherein the at least one aliphatic and acyclic alkene of the copolymer or the copolymer mixture of the aqueous composition for sealing in step (i) is selected from ethene and/or propene.

6. The method according to claim 1, wherein the α,β-unsaturated carboxylic acid of the copolymer or of the copolymer mixture of the aqueous composition for sealing in step (i) is selected from cinnamic acid, crotonic acid, fumaric acid, itaconic acid, maleic acid, acrylic acid and/or methacrylic acid.

7. The method according to claim 1, wherein the α,β-unsaturated carboxylic acid of the copolymer or of the copolymer mixture of the aqueous composition for sealing in step (i) is selected from acrylic acid and/or methacrylic acid.

8. The method according to claim 1, wherein at least 20%, but no more than 60% of the acid groups of the copolymer or of the copolymer mixture in the aqueous composition for sealing is present in neutralized form.

9. The method according to claim 3, wherein at least 30%, but no more than 50% of the acid groups of the copolymer or of the copolymer mixture in the aqueous composition for sealing is present in neutralized form.

10. The method according to claim 4, wherein at least 20%, but no more than 50% of the acid groups of the copolymer or of the copolymer mixture in the aqueous composition for sealing is present in neutralized form.

11. The method according to claim 1, wherein the contacting step (i) takes place by applying a wet film of the aqueous composition for sealing by a spraying or by a dipping process.

12. The method according to claim 1, wherein the contacting step (i) takes place by applying a wet film of the aqueous composition for sealing by a dipping process, wherein, after termination of the dipping process, excess wet film is removed before the drying and/or curing step (ii) is carried out, such that a wet film adhering in a homogeneous film thickness is formed.

13. The method according to claim 1, wherein the metal substrate is selected from aluminum, magnesium and/or titanium.

14. The method according to claim 1, wherein the oxide protective layer is substantially made of oxides and/or hydroxides of the elements Si, Ti, Zr, Nb, Ta and/or Sn.

15. The method according to claim 1, wherein the metal substrate is selected from, magnesium and/or aluminum and the oxide protective layer is substantially made of oxides and/or hydroxides of the elements Si, Ti and/or Zr.

16. The method according to claim 1, wherein the supplying of thermal energy in step (ii) results in a peak temperature of the metal substrate of at least 120° C., but less than 200° C. (PMT, so-called peak metal temperature).

17. The method according to claim 1, wherein, after step ii), an amount of organic solid components of the aqueous composition for sealing remains on the oxide protective layer such that, with complete pyrolysis, the cured seal releases an amount of at least 1 g CO₂, but no more than 20 g CO₂.

18. The method according to claim 8, wherein the metal substrate is an aluminum substrate and the protective layer is based on oxides and/or hydroxides of the elements Si, Ti and/or Zr and has a thickness of at least 2 μm.

19. The method according to claim 18, wherein the protective layer is based on oxides and/or hydroxides of the element Ti and has a density of less than 3.5 g/cm³.
